(19) United States
(12) Patent Application Publication
(10) Pub. No.: US 2017/0049037 A1
(43) Pub. Date: Feb. 23, 2017

(54) ROLLING HARROW/ROLLER TILLAGE TOOL

(71) Applicant: Unverferth Manufacturing Co., Inc., Kalida, OH (US)

(72) Inventors: Michael J. HILVERS, Fort Jennings, OH (US); Thomas STEFFAN, Cloverdale, OH (US); Shawn W. GERDEMAN, Delphos, OH (US)

(73) Assignee: Unverferth Manufacturing Co., Inc., Kalida, OH (US)

(21) Appl. No.: 15/239,492

(22) Filed: Aug. 17, 2016

Related U.S. Application Data
(60) Provisional application No. 62/207,538, filed on Aug. 20, 2015.

(51) Int. Cl. A01B 49/02; A01B 27/00; A01B 23/04; A01B 21/08; A01B 23/02

(52) U.S. Cl. CPC A01B 49/027; A01B 21/086; A01B 23/02; A01B 23/046; A01B 27/005

(57) ABSTRACT

A farm implement for tilling soil including a frame having a transverse axis. The farm implement includes a plurality of ground engaging tools coupled to the frame extending parallel to the transverse axis. At least one of the plurality of ground engaging tools includes a roller having a solid outer surface.

### CROSS-REFERENCE TO RELATED APPLICATIONS

This application claims priority to U.S. Provisional Patent Application Ser. No. 62/207,538, filed on Aug. 20, 2015, the disclosure of which is incorporated herein by reference in its entirety.

### BACKGROUND OF THE INVENTION

Field of the Invention

The present invention is related generally to a farm implement for tilling soil, and, more particularly, to a farm implement for tilling soil that uses roller which has a solid outer surface.

Description of the Related Art

Farm implements for tilling soil are known in the art. Such implements typically include both ground engaging tools to dig into the soil and finishing tools to further manage the soil. A known finishing tool is a rolling harrow cylindrical basket, which is made of twisted flat bars creating a cage-like outer surface. The rolling harrow cylindrical basket design fluffs the soil while resizing the clods of dirt to a manageable size for planting seed.

Some soils have a very fluffy consistency which actually needs to be firmed or compacted to form an ideal seedbed by eliminating some of the air in the soil to get a good seed to soil contact for improved emergence.

### SUMMARY OF THE INVENTION

In accordance with a first aspect of the present invention, a farm implement for tilling soil includes a frame having a transverse axis. The farm implement further includes a plurality of ground engaging tools coupled to the frame extending parallel to the transverse axis. At least one of the plurality of ground engaging tools includes a roller having a solid outer surface. The roller further includes a set of ribs or teeth on the solid outer surface.

In some embodiments, the roller having a solid outer surface is a solid-surface cylindrical drum. In some embodiments, at least one of the plurality of ground engaging tools comprises a cylindrical basket. In some embodiments, the set of ribs or teeth on the solid outer surface includes a ring welded to the solid outer surface of the roller. In some embodiments, the set of ribs or teeth forms a repeating pattern and in other embodiments forms an irregular pattern.

### BRIEF DESCRIPTION OF THE DRAWINGS

FIG. 1 is a perspective view of a -related art farm implement.

FIG. 2 is a perspective view of a finishing tool according to an exemplary embodiment of the present invention.

FIG. 3 is a side view of a set of ribs or teeth on a roller according to an exemplary embodiment of the present invention.

### DETAILED DESCRIPTION OF THE PRESENT INVENTION

While the present invention may be embodied in many different forms, a number of illustrative embodiments are described herein with the understanding that the present disclosure is to be considered as providing examples and not intended to limit the invention to the embodiments described and/or illustrated herein.

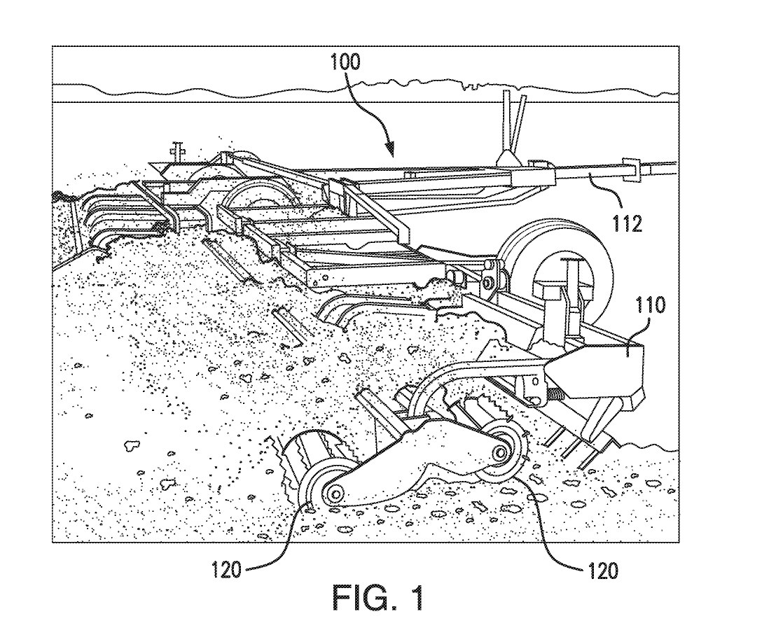

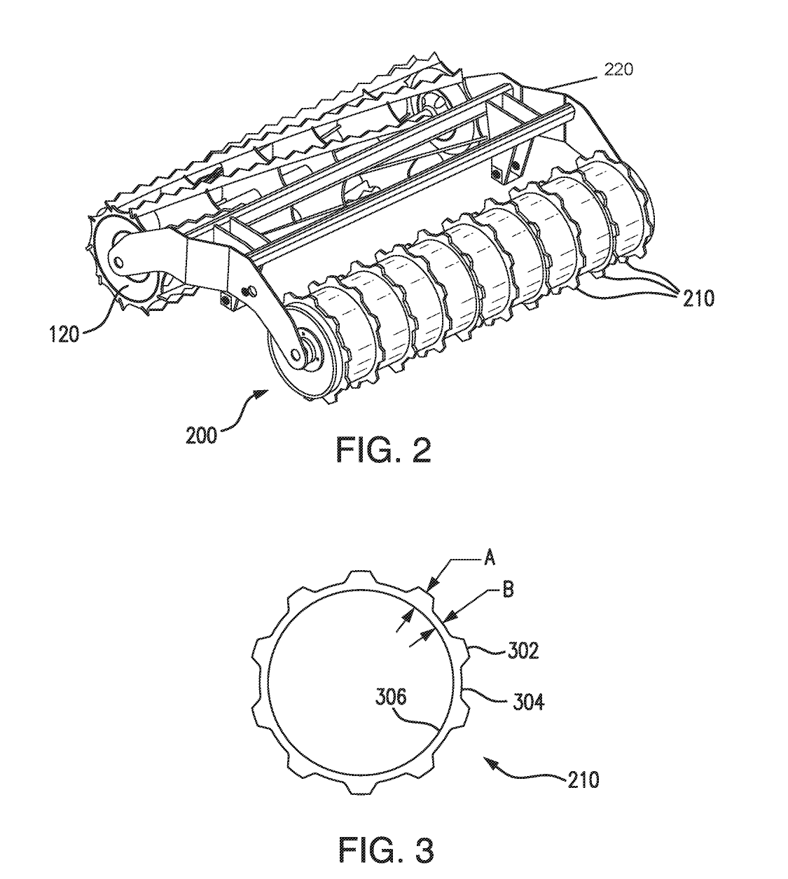

FIG. 1 illustrates a farm implement 100 for tilling. The farm implement 100 includes a frame 110 having a transverse axis, a tow hitch 112, transport wheels, rows of ground engaging tools and rows of finishing tools 120. The finishing tools depicted in FIG. 1 are rolling harrow cylindrical baskets 120. These cylindrical baskets are made of twisted flat bars, forming a cage. In contrast, the roller 200 (as shown in FIG. 2) has a solid outer surface that tends to pack and firm the soil rather than fluffing the soil. The roller 200 can also press rocks into the soil to prevent them from entering the farm implement. In some embodiments, the roller 200 may be a solid surface cylindrical drum. In some embodiments, the solid surface cylindrical drum has a length of from three feet to six feet and a diameter of from about half a foot to about two feet, for example, about 15½ inches.

In some embodiments, farm implement 100 may be used for harvesting.

In some embodiments, the roller 200 includes a set of ribs or teeth 210. As shown in FIG. 3, the set of ribs or teeth 210 may include a lug ridge 302, a lug valley 304, and a solid surface 306. In accordance with some embodiments, lug ridge 302 has a height A and the lug valley 304 has a height B. In one embodiment, the set of ribs or teeth 210 comprises a ring that is welded to the solid surface 306. In one embodiment, the ring is manufactured as two halves that can be put together, to improve manufacturing efficiency. In some embodiments, the ring is from about ⅛th of an inch thick to about an inch thick, for example about ⅜^{th} of an inch thick. In some embodiments, the height A of the lug ridge 302 is from about one inch thick to about three inches thick, for example about one and 5/16^{th} inches thick. In some embodiments, the height B of the lug valley 304 is from about ⅛^{th} of an inch thick to about two inches thick, for example about 9/16^{th} of an inch thick. In some embodiments, a usable lug height is from about ½ of an inch to about 1 inch, for example about ¾ of an inch. The set of ribs or teeth 210 may be of any size, shape, or pattern.

In accordance with some embodiments, the set of ribs or teeth 210 may be spaced apart from each other in a uniform manner, from about 3 inches to about 18 inches, and in some embodiments the spacing may be about 6 inches apart.

In some embodiments, set of ribs or teeth 210 are symmetrical, that is, the lug ridges 302 and lug valleys 304 are symmetrically spaced along a single rib 210. In such embodiments where the set of ribs or teeth 210 are symmetrical, roller 210 is therefore non-directional.

In some embodiments, the thickness and height of the ribs or teeth 210 may affect the robustness of the roller 200 when it is hitting debris such as rocks. For example, thicker and shorter ribs may result in a more robust roller.

In some embodiments, roller 200 has a replaceable shaft and bearing with square bores for positive bearing engagement.

The set of ribs or teeth 210 perform at least three primary functions:

First, the set of ribs or teeth 210 can grip the soil while travelling through the field to ensure the roller 200 continues to roll (instead of being static) and continues to plow soil (instead of merely rolling over the top of it).

Second, the set of ribs or teeth 210 can cause a pinching action on residue remaining on the surface of the ground. The set of ribs or teeth 210 can pinch the stalks into the ground securing them to aid in the prevention of soil erosion and movement of the residue across the surface of the field by wind and water.

Third, the set of ribs or teeth 210 can create pockets in the soil surface to capture and hold water, thereby aiding in erosion prevention and also nourishing the seeds.

In some embodiments of the present invention, a farm implement 100 for tilling soil includes a frame 110 having a transverse axis. The farm implement further includes a plurality of ground engaging tools 120, 200 coupled to the frame 110 extending parallel to the transverse axis. At least one of the plurality of ground engaging tools 120, 200 includes a roller 200 having a solid outer surface. In some embodiments, the rolling harrow cylindrical baskets 120 and the rollers 200 are interchangeable on a given basket frame, so that a consumer may utilize any combination of baskets 120 or rollers 200 as desired depending on soil type and desired results.

The farm implement 100 may be towed via tow hitch 112 by a tractor or other equipment.

In accordance with some embodiments, one or more ground engaging tool may be coupled to an oscillating support unit 220 which is in turn coupled to the frame 110. For example, oscillating support unit 220 may include basket 120 coupled to one side and roller 200 coupled to the other side of the support unit, or it may have rollers 200 coupled to both sides of the support unit. Support unit 220 may be coupled to the frame such that it is permitted to oscillate, allowing basket 120 to move vertically in one direction and roller 200 to move vertically in an opposite direction.

From the above it will be appreciated that the farm implement for tilling of the present invention provides for improved tilling. It will also be appreciated that various changes can be made to the system without departing from the spirit and scope of the appended claims. For example, the farm implement may be propelled by tracks or treads instead of wheels. In another example, the farm implement may be self-propelled by motors rather than towed. In a further example, the motors can be gas, electric or hydraulic drive motors, or some combination of the foregoing types of drive motors. In another example, the farm implement can be used to till a variety of different field types, including flat, hilly, rocky, or rolling fields or fields with swales, etc. These and other modifications are intended to be encompassed within the scope of the appended claims.

We claim:

1. A farm implement for tilling soil comprising:
a frame having a transverse axis; and
a plurality of ground engaging tools coupled to the frame extending parallel to the transverse axis,
wherein at least one of the plurality of ground engaging tools includes a roller having a solid outer surface,
wherein the roller further includes a set of symmetrical ribs or teeth on the solid outer surface.

2. The farm implement of claim 1, wherein the roller having a solid outer surface is a solid-surface cylindrical drum.

3. The farm implement of claim 1, wherein at least one of the plurality of ground engaging tools comprises a cylindrical basket.

4. The farm implement of claim 1, wherein the set of ribs or teeth on the solid outer surface comprises a ring welded to the solid outer surface of the roller.

5. The farm implement of claim 1, wherein the set of ribs or teeth forms a repeating pattern.

6. The farm implement of claim 1, wherein the set of ribs or teeth forms an irregular pattern.

7. A farm implement for tilling soil comprising:
a frame having a transverse axis; and
an oscillating support unit coupled to the frame having a first ground engaging tool coupled to the support unit at one side and a second ground engaging tool coupled to the support unit at the other side,
wherein at least one of the first and second ground engaging tools includes a roller having a solid outer surface.

8. The farm implement of claim 7, wherein the first and second ground engaging tools are different types of tools.

9. The farm implement of claim 7, wherein the oscillating support unit allows the first ground engaging tool to move in a vertical direction and the second ground engaging tool to move in the opposite vertical direction.
